(19) United States
(12) Patent Application Publication
(10) Pub. No.: US 2021/0145193 A1
(43) Pub. Date: May 20, 2021

(54) Travel Tray Table Cover

(71) Applicant: Denise Presley, Casselberry, FL (US)

(72) Inventor: Denise Presley, Casselberry, FL (US)

(21) Appl. No.: 17/015,214

(22) Filed: Sep. 9, 2020

Related U.S. Application Data
(60) Provisional application No. 62/937,835, filed on Nov. 20, 2019.

(51) Int. Cl. A47G 11/00; B64D 11/06; B60N 3/00

(52) U.S. Cl. CPC A47G 11/004; B60N 3/004; B64D 11/0638

(57) ABSTRACT

This present application discloses a seat back tray table cover that helps to reduce the transmission of germs and diseases. The tray table cover is a disposable, relatively thin piece of plastic that substantially encompasses the seat back tray table including, without limitation, both a bottom and a top surface thereof. More specifically, the tray table cover slips around the seat back tray table, and then is secured around the two bars that attach the seat back tray table to the back of the seat. The tray table further comprises an anti-bacteria and an anti-microbial coating on its outside surface.

### CROSS-REFERENCE TO RELATED APPLICATION

The present application claims priority to, and the benefit of, U.S. Provisional Application No. 62/937,835, which was filed on Nov. 20, 2019 and is incorporated herein by reference in its entirety.

### BACKGROUND

The present invention relates generally to a cover or sleeve for a tray table. More specifically, the present invention relates to a disposable tray table cover or sleeve for an airline, bus, train, boat, camper or other vehicle tray table that reduces or eliminates the spread of unwanted germs and diseases that can be transmitted while traveling. The disposable tray table cover or sleeve easily slips onto the tray table and covers the top surface, the bottom surface and edges of the tray table, and may be secured through a fastening means such as fastening threads that tie onto the handles or supports of the tray table. Accordingly, the present specification makes specific reference thereto and, it is to be appreciated that aspects of the present invention are also equally amenable to other similar applications.

By way of background, people traveling on longer routes often travel via airplane and other modes of transportation. Also, public transportation, such as trains, boats, ferries, subways and buses are common for daily travel to places of employment, worship, schooling and the like. Usually, these public transports have a folding tray table positioned on the back of forward seat, which provides a supporting tray for eating meals, having drinks, working on a laptop, keeping lightweight luggage such as a purse, reading books, playing games, and for a variety of other purposes. Such folding tray tables are used frequently by many passengers each day and, therefore, may retain harmful germs, pathogens, bacteria and other undesirable microorganisms. For example, studies have found that airplane tray tables have the most bacteria of any surface in the airplane's cabin with an average of 2,155 colony-forming units per square inch. Even with routine cleaning by employees such as airline staff, train or bus staff, the germs are not completely removed and remain on the surface. These germs on the tray table surface may easily be transferred to a person while using the tray table for any purpose, and may lead to the spread of disease if the person touches, for example, their eyes, mouth, nose, or other individuals in close proximity to the user.

Also, an additional drawback of the traditional folding tray table is that the tray table is often made of a plastic material that can be excessively smooth and slippery. This creates a problem when items are placed on the tray table and may slide uncontrollably around and off of the tray table when the vehicle or plane is in motion, thereby possibly causing injury and/or damage to the items in addition to spillage and staining of the surrounding area and the traveler's clothes. A table tray with gripping capability is required for users.

In an effort to alleviate some of the forgoing concerns, disposable paper such as a napkin may sometimes be placed on the folding tray table before any meal or beverage is served to the traveler. However, if the meal and/or drink spills on the tray table, the paper absorbs some food and/or liquid, but creates a mess for the passenger. Further, the paper material is not anti-bacterial and, in fact, may act as a mode of microbe transmission and facilitate the spread of various pandemic diseases.

Therefore, there exists a long felt need in the art for a tray table cover that prevents germs from remaining on any of the surfaces of the tray table and contaminating the individual or his or her personal property. There also exists a long felt need in the art for a disposable tray table cover that protects users from disease transmission when using the tray tables. Moreover, there exists a long felt need in the art for a tray table cover that is uniquely designed to cover all the surfaces of the tray table to maintain the safety of the traveler, and for a tray table cover which has a gripping capability. Additionally, there is a long felt need in the art for a tray table cover that remains secured to the tray table and is not displaced during use, and that is reversibly fitted to an airline or other means of travel tray table. Finally, there is a long felt need in the art for a tray table cover which is anti-bacterial, anti-microbial and protects the tray table surface from retaining or transferring any germs to the traveler or his or her personal property.

The subject matter disclosed and claimed herein, in one embodiment thereof, relates to an airplane tray table cover comprised of a plastic cover body and a plurality of fastening threads extending outwardly from the side edges of the table cover body. The disposable tray table cover of the present invention is configured to reversibly attach to the travel tray table to provide a sanitary cover. The disposable travel tray table cover body further comprises a top surface to cover the top face of the tray table, a rear surface to cover the bottom portion of the tray table, an open edge through which the cover slips onto the tray table, and a closed or sealed edge that lies along with the edge of the tray table nearest the passenger. More specifically, the side edges of the tray table cover have fastening threads along their that extend outwardly from the side edges to tie the cover to the handles or supports of the tray table to form a removably secure connection thereto. The fastening threads ensure that the table cover is firmly secured to and is not displaced during use by the passenger, and or movement by the underlying mode of transportation. In a preferred embodiment of the present invention, the cover body is comprised of a relatively thin and flexible plastic with anti-slip, anti-microbial and anti-bacterial coatings incorporated therein.

In this manner, the disposable table tray cover of the present invention accomplishes all of the forgoing objectives, and provides a relatively inexpensive and easy solution to provide a sanitary dining and work space for the passenger while traveling.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one embodiment thereof, comprises a travel tray table cover having a plastic cover body and fastening threads extending outwardly from the side edges of the table cover. The disposable tray table cover of the present invention is configured to reversibly attach to a seat back or travel tray table to provide a sanitary cover to the same, and prevent the transmission of germs, bacteria, disease and the like. The disposable tray table cover includes a top surface to cover the top face of the tray table, a rear surface to cover the bottom portion of the tray table, an open edge through which the cover slips onto the tray table, and a closed edge for the edge of the tray table nearest or immediately adjacent to the passenger or facing the seat of the passenger. The side edges of the tray table cover further comprise fastening threads along their length that extend outwardly from the side edges to tie or removably secure the tray table cover to the handles or supports of the tray table. The fastening threads ensure that the table cover is firmly secured, and is not displaced during use by the passenger and/or the movement caused by the underlying mode of transportation. The material of the cover body is preferably comprised of a relatively thin and flexible plastic having anti-slip, anti-microbial and anti-bacterial properties.

In another exemplary embodiment of the presently described invention, a method of covering the tray table with the new and innovative tray table cover is provided to as to ensure a sanitary dining, playing and workspace for the traveling passenger. The method includes providing a tray table cover, the cover having a relatively thin and flexible plastic cover body, and fastening threads that can be used to secure the cover body to the handles or supports of the tray table that attach the table to the back portion of the seat immediately in front of the traveling passenger. The cover is then slipped onto the tray. Once the cover is in place and substantially encapsulates the tray table, the fastening threads are tied with a knot, wrapped or rolled around the handles that support the tray table, thereby creating a secure but removable connection between the tray table and the tray table cover. Once the tray table cover is securely in place, the airline passenger can use the tray table cover to keep food items, beverages, games, laptops, smartphones, papers, pens, pencils, and any other items that would be conveniently kept on the tray table. After use, such at the end of the journey or in between a journey, the tray table cover can be removed or replaced by loosening the threads from the handles and pulling the tray table cover off of the tray table, and properly disposed of. In this manner, the tray table cover of the present invention provides a disposable, inexpensive, safe, and easy way to protect passengers from the pathogens and other disease-causing germs often found on such travel trays. Further, because the tray table cover of the present invention slides over the tray table, a passenger can leave the cover on the tray table and still easily close the tray table without having to unwrap the threads that secure the tray table cover to the tray table, for example, during landing or take-off of an airplane.

In yet another exemplary embodiment of the presently described invention, the table cover can be reversibly fitted by removing the tray table tray cover from the tray and reverse the direction of the cover in an up-side down manner and making the rear surface cover the top surface of the tray table. The fastening threads securely hold the cover in position on the tray table.

According to an exemplary embodiment of the present invention, the top surface and the rear surface of the tray table cover is preferably made of the same material and contains an anti-slip, anti-microbial and anti-bacterial coating on at least its exterior surface. In a preferred embodiment of the present invention, the tray table cover body may further comprise one or more foldable joints that can be manipulated to customize the size of the travel tray table cover to more securely fit a particular application.

In a further exemplary embodiment of the present invention, a protective cover and tray table combination is described and includes a seat back travel tray having a dimension of at least 16.5″ wide, 9.5″ deep and a thickness of 0.5″. The seat back travel tray is secured to the rear of a forward seat by at least one support arm and movable from a closed position to an open position. A protective travel tray cover is sized and configured to fit over and substantially encapsulate the seat back travel tray. The protective travel tray cover has a front surface, a back surface, opposing sides, a front edge, and a rear edge. Securing threads attached to the sides of the protective cover and the protective cover is formed from a flexible material with a thickness of at least 6 mils.

In a still further exemplary embodiment of the presently described invention, a method of using a protective tray table cover is described. In one embodiment, the method comprises the initial step of providing a seat back tray table having a dimension of at least 16.5″ wide, 9.5″ deep and a thickness of 0.5″. The seat back travel tray is secured to a seat by at least one support arm and is movable from a closed position to an open position. The next step is providing a protective tray table cover that is sized and configured to substantially encapsulate the seat back travel tray, wherein the tray table cover is comprised of a front surface, a back surface, opposing sides, an open front edge, a closed rear edge, and a plurality of securing elements attached to, and extending outwardly from, each of the sides of the tray table cover. In the next step, the tray table cover is positioned over the tray table, thereby substantially encapsulating the same. Finally, the tray table cover is removably secured to the tray table by attaching the securing elements to the tray table arms.

The travel tray table cover of the present invention adds additional value to the well-being, health and safety of the passengers, and adds income for the transportation service by offering a disposable tray table cover to first class passengers and selling the tray table cover to coach passengers as an add-on amenity. Alternatively, the first-class passengers may also have to purchase the cover as per the transportation provider's policy, and as a way of further increasing revenue.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of the disposable travel tray table cover of the present invention in accordance with the disclosed structure;

FIG. 2 illustrates a perspective view of one potential embodiment of the disposable travel tray table cover about to be installed on a seat back tray table in accordance with the disclosed structure;

FIG. 3 illustrates a perspective view of one potential embodiment of the disposable travel tray table cover partially installed on a seat back tray table in accordance with the disclosed structure; and

FIG. 4 illustrates a perspective view of one potential embodiment of the disposable travel tray table cover installed on a seat back tray table in accordance with the disclosed structure, wherein the travel tray table cover is secured to the travel tray via the securing elements.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the present invention can be practiced without each or combinations of these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long felt need in the art for a travel tray table cover that prevents germs from transferring from any of the surfaces of the tray table to a passenger, their belongings or another individual. There also exists a long felt need in the art for a disposable tray table cover that protects travelers and other individuals from disease transmission when using the tray tables, and that is uniquely designed to cover all the surfaces of the tray table (i.e., not just the top surface). Additionally, there is a long felt need in the art for a tray table cover which has a gripping or securing capability to prevent objects that are placed thereon from sliding, and for a tray table cover that is secured to the tray table and is not easily displaced (e.g., during movement caused by the underlying mode of transportation). Moreover, there is a long felt need in the art for a tray table cover which is reversibly fitted to a travel tray table. Finally, there is a long felt need in the art for a tray table cover which is anti-bacterial, anti-microbial and that protects the tray table surface from transferring any germs, bacteria or other pathogens to the passenger, his or her belongings, or other individuals.

The present invention, in one exemplary embodiment, is a unique and disposable airplane tray table cover that is capable of substantially encapsulating a travel tray table. It should be understood that while in one embodiment reference is made to an airplane seat back travel table tray cover, the table tray cover of the present invention may be used to cover or encapsulate table trays that are routinely found on other modes of transportation including, without limitation, buses, boats, trains, campers, and the like.

The subject matter disclosed and claimed herein, in one embodiment thereof, is a travel tray table cover that comprises a plastic cover body and fastening threads extending outwardly from the side edges of the cover body. The disposable tray table cover of the present invention is configured to reversibly attach to a seat back tray table, such as the type commonly found on an airplane to provide a sanitary cover thereto. The disposable seat back tray table cover body if further comprised of a top surface to cover the top face of the tray table, a rear surface to cover the bottom portion or surface of the tray table, an open edge through which the cover slips onto the tray table, opposing side edges (to which the fastening threads are attached), and a closed edge that aligns with the edge of the tray table nearest to or facing the airplane passenger. The fastening threads along the length of the side edges may be tied to the handles or supports of the tray table to removably secure the tray table cover to the tray table once properly installed. More specifically, the fastening threads ensure that the tray table cover is firmly secured to the tray table and is not easily displaced during use by the passenger or individual, or during movement caused by the underlying mode of transportation. The tray table cover body is preferably comprised of a relatively thin and flexible plastic with anti-slip, anti-microbial and anti-bacterial properties. Further, the disposable tray table cover of the present invention may be available in various sizes, colors, prints and designs to accommodate all user needs and/or preferences. Accordingly, the exact size, measurement, construction, and design of the disposable tray table cover of the present invention may vary.

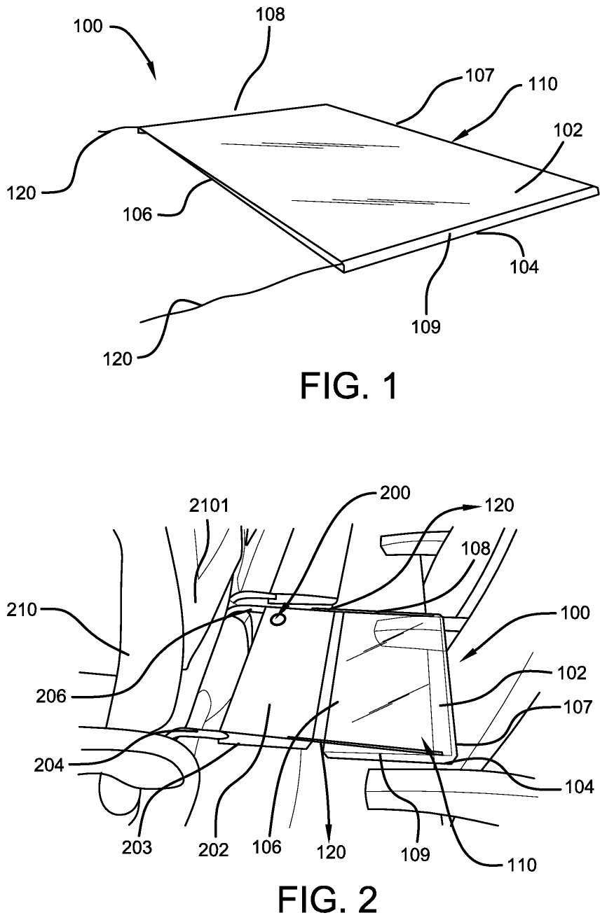

Referring initially to the drawings, FIG. 1 illustrates a perspective view of one potential embodiment of the disposable tray table cover or sleeve 100 of the present invention in accordance with the disclosed structure. More specifically, the disposable tray table cover 100 is comprised of a plastic cover body 110 and fastening threads 120 that extend outwardly from each of the side edges 108, 109 of the cover body portion 110. The plastic cover body 110 preferably has a thickness of approximately 6 mils, but may be thicker so as to provide enhanced durability, between 6 and 10 mils for example. The tray table cover or sleeve 100 of the present invention is configured to reversibly attach to, or substantially encapsulate, a seat back tray table 200 to provide a sanitary and protective covering thereto. In FIG. 1, the tray table cover 100 is shown to have a substantially rectangular shape to conform to the shape of the seat back tray table 200. However, it is contemplated that the tray table cover 100 of the present invention could be any shape or size necessary to fit a particular application.

The plastic cover body 110 of the disposable tray table cover 100 is comprised of a top surface 102, a rear or bottom surface 104, an open edge 106, a closed edge 107, a right edge 108 and a left edge 109. The fastening threads 120 runs along and are securely attached to the right edge 108 and the left edge 109 of the tray table cover 100, and extend outwardly from the edges 108, 109 to fasten with the two bars or support arm of the seat back tray table 200 present in front of the passenger. More specifically, the tray table cover 100 slips over the tray table 200 through the open edge 106, thereby substantially enveloping or encapsulating the travel tray 200, and the cover 100 may be firmly secured in place by tying or wrapping the fastening threads 120 around the two bars or support arms that attach the seat back tray table 200 to the back of the seat in front of the passenger. When the tray table cover 100 is in place on tray table 200, the closed edge 107 of the cover body 110 aligns with the edge of the tray and holds the cover 100 to the tray table 200.

Additionally, the top surface 102 and rear surface 104 have a substantially flat surface configured to provide a sanitary and protective surface for receiving articles of a passenger. In a preferred embodiment, each of the top and rear surfaces 102, 104 of the tray table cover 100 is made from a single layer of material. Further, the fastening threads 120 may be glued by an adhesive to both the right and left edges 108, 109 of the body portion 110, thereby providing a strong connection or attachment of the fastening threads 120 to the edges 108, 109 which prevents the unwanted displacement of the cover 100 once firmly secured to the tray table 200. Alternatively, the fastener threads 120 may be bonded to the body portion 110, or included as part of the extrusion or manufacturing process of the tray table cover 100.

According to an embodiment of the present invention, the disposable tray table cover 100 may include one or more of an anti-bacterial, anti-microbial and/or anti-slip protective coating. The protective coating(s) may be applied to the outer surfaces of the body portion 110 or be otherwise incorporated into their manufacturing. For example, in one embodiment, the protective coating may be a coating that is resistant to bacteria, microbes and other pathogens and is applied to the top, rear and side surfaces 102, 104, 108 and 109. In an alternate embodiment, the anti-bacterial, anti-microbial component may be a material used to manufacture the seat back tray table cover 100 that is resistant to bacteria, microbes and other pathogens. The protective component is intended to be incorporated or embedded into the tray table cover 100 to provide a clean and hygienic surface for dining, working, etc.

FIG. 2 illustrates a perspective view of one potential embodiment of the disposable travel tray table cover 100 about to be installed on a seat back tray table 200 in accordance with the disclosed structure. In a preferred embodiment, the disposable tray table cover 100 is sized and configured to have approximately the same size and shape of the tray table 200, which is attached to a back portion 2101 of a seat 210 in front of a passenger through left handle 204 and right handle 206. The average dimensions of a seat back tray table 200 are approximately 16.5″ wide and having a depth of between 9.5″ and 10.5″. Further, most seat back tray tables 200 have a thickness of between 0.5″ to 2″, depending on the manufacturer of the tray table and the type of transportation for which it is being used. Accordingly, the tray table cover 100 of the present invention should be manufactured with a configuration and size to substantially encompass the seat back tray table 200 with minimal effort by the user.

To use the tray table cover 100, a user, such as a passenger on an airplane, will simply pull down the tray table 200 to an open or table-like position and then attach the disposable tray table cover 100 to the tray table 200 by sliding the tray table cover 100 over the edge of the tray table 200 through an open edge 106 in the plastic cover body 110. The plastic cover body 110 is secured firmly to the table 200 through the fastening threads 120 extending outwardly from the sides 108, 109 of the body portion 110, and tied or wrapped on the left handle or support arm 204 and the right handle or support arm 206 of the tray table 200. While attaching the disposable tray table cover 100 to the tray table 200, the top surface 102 slides on the tray table top surface 202 and the bottom or rear surface 104 slides along the tray table bottom surface 203. The right edge 108 and left edge 109 of the cover body 110 touches the edges of the tray table 200 so that there is a close fit of the cover 100 to the tray table 200.

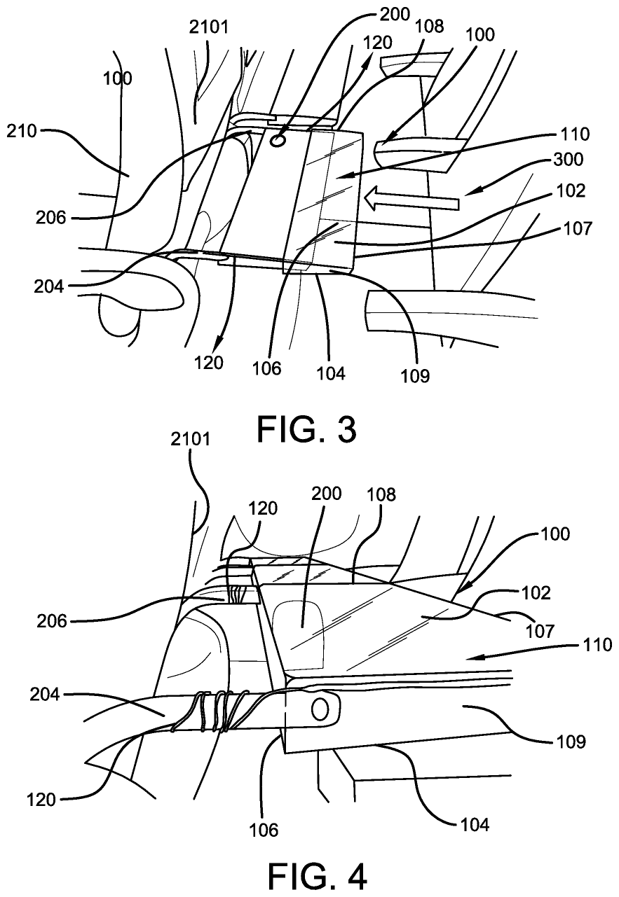

FIG. 3 illustrates a perspective view of one potential embodiment of the disposable travel tray table cover 100 partially installed on a seat back tray table 200 in accordance with the disclosed structure. More specifically, the disposable seat back tray table cover body 110 covers the travel tray table 200, and provides a sanitary surface for dining, working, reading, playing games and the like. As best shown in FIG. 3, the cover body portion 110 completely covers the tray table top surface 202, side edges, and the tray table bottom surface 203. The fastening threads 120 extending outwardly from the edges 108, 109 are fastened, wrapped, or tied onto the left and right handles 204 and 206 of the tray table 200 to secure the tray table cover body 110 to the tray table 200. To replace or remove the cover 100, the fastening threads 120 can be loosened, unwrapped or untied, and the cover body 110 can be removed by pulling the cover in a lateral direction away from the table 200 and in the direction of the seated passenger making use of the tray table 200.

FIG. 4 illustrates a perspective view of one potential embodiment of the disposable travel tray table cover 100 installed on a seat back tray table 200 in accordance with the disclosed structure, wherein the travel tray table body portion 110 is secured to the travel tray 200 via the securing elements 120. The table tray cover or sleeve 100 is preferably transparent and is made up of relatively thin and flexible plastic material, such that the traveler does not feel any change in condition of the tray 200 during its use with the cover thereon. More specifically, the tray table cover 100 does not materially alter the height, length or width of the travel tray 200 so as to reduce the overall area that the individual has while seated. The tray table cover body 110 also preferably substantially conforms to the shape of the travel tray 200. It is contemplated that the travel tray table cover 100 can be provided to business class and/or first-class passengers as a courtesy, and may be made available for purchase at a nominal price for economy class passengers.

In a preferred embodiment, the cover or sleeve 100 may be further comprised of one or more foldable joints along any of the edges of the cover to permit the tray table cover 100 to be precisely folded. The fastening thread 120 is removably tied to or wrapped around the handles or supporting arms 204 and 206 of the tray 200, which are attached to the back portion 2101 of the seat 210 in front of the passenger. Alternatively, if the travel tray 200 is pulled from the arm rest, the cover or sleeve of the present invention is readily adapted to fit over the travel tray through the opening in the cover or sleeve. The tray table cover 100 can remain attached to the tray table 200 even in the closed position wherein the tray table 200 is in the upright and locked position such as by a hinge on the back portion 2101 of the seat 210 in front of the passenger when not in use. In a further embodiment, the table cover body 110 may be further comprised of a circular cup holding section, like the cup holding section present in the tray table 200.

It is contemplated that the relatively thin transparent material used in the various embodiments of the tray table cover 100 of the present invention may be comprised of a transparent or translucent plastic, plexiglass, or other suitable material. In other embodiments, the tray table cover 100 may be opaque to hide the appearance of the tray table 200. Further, the tray table cover 100 may be of any color, as per user preference or can be of a color matching the aesthetic look of the airplane decor.

According to an embodiment of the present invention, the cover body 110 is constructed from a resilient and generally flexible material. Further, a high friction material or anti-slip material may be used to construct the cover body 110. The anti-slip material creates a non-slip surface on the surfaces 102, 104 of the disposable tray table cover 100 that reduces the chance that an item placed on the tray table cover 100 will slide around uncontrollably. One of ordinary skill in the art would appreciate that there are numerous suitable anti-slip coatings or materials that may be used in conjunction with tray table cover 100.

According to an embodiment of the present invention, the fastening threads 120 may include one or more fastener elements to fasten to the handles 204, 206. In a preferred embodiment, the fastener elements may be one or more of a clip, a clasp, a hook, a loop, a snap, a button, a hook-and-loop fastener or the like. In an alternative embodiment, there is a fastener element attached to each end of the fastening thread 120. The fastening thread 120 may also be rubberized, or elastic, so that it can more readily grip the support arms 204, 206 and stretch as needed to complete the securement of the travel tray cover 100 to the travel tray seat back 200. This arrangement allows the fastener elements on the fastening strap 120 to reversibly engage with the fastener elements on the airline tray table cover 100, thereby permitting the fastening straps 120 to be reversibly engaged with the airline tray table cover 100. The fastening threads 120 may also be comprised of other durable and relatively strong thread materials including, without limitation, polyester, nylon, plastic, cotton, linen, and the like. It is also contemplated that the table tray cover may comprise a germ and antibacterial film/covering on its interior that is capable of killing 99.99% of the germs and bacteria that it comes into contact with.

The disposable tray cover 100 of the present invention permits for disposable usage, thereby preventing the further spread of disease-causing microorganisms, germs, bacteria, microbes and the like beyond the airplane and/or airport, or from seated passenger to seated passenger. Further, the travel tray cover 100 provides for a sanitary tray table cover that prevents contamination from the seat back as the table is repositioned from the “closed” to “open” positions, and vice versa. The travel tray cover 100 is disposable, and relatively easy and inexpensive to manufacture and use.

Certain terms are used throughout the description and claims to refer to features or components. As one skilled in the art will appreciate, different persons may refer to the same feature or component by different names. This document does not intend to distinguish between components or features that differ in name, but not structure or function. As used herein “table cover,” “seat back tray table,” “disposable airplane table cover,” “cover,” “tray table cover”, and the like are interchangeable, and refer to the disposable tray table cover 100 of the present invention.

Notwithstanding the forgoing, the disposable tray table cover 100 of the present invention, and its various components, can be of any suitable size and configuration as is known in the art without affecting the overall concept of the invention, provided that the accomplish the above stated objectives. One of ordinary skill in the art will appreciate that the size, configuration and materials of the disposable tray table cover 100 as shown in the FIGS. are for illustrative purposes only, and that many other sizes and configurations of the disposable tray table cover 100 are well within the scope of the present disclosure. Although the dimensions of the disposable tray table cover 100 are important design parameters for user convenience, the disposable tray table cover 100 may be of any size that ensures optimal performance during use and/or that suits user need and/or preference.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A protective sleeve comprising;
a sleeve formed from a low-cost flexible material, the sleeve having a top surface, a bottom surface, a pair of opposed side edges, an open end and a closed end, wherein the sleeve is sized and configured to fit on a seat back travel tray for a passenger service transportation company; and
a fastening device for securing the sleeve to the seat back travel tray.

2. The protective sleeve as recited in claim 1, wherein the sleeve has an anti-microbial component and an anti-bacterial component incorporated into the sleeve.

3. The protective sleeve as recited in claim 1, wherein the sleeve is constructed from a plastic material having a thickness of between 6 and 10 mils.

4. The protective sleeve as recited in claim 1, wherein the sleeve has a deformation in the top surface to correspond to a deformation in the seat back travel tray.

5. The protective sleeve as recited in claim 1, wherein the sleeve has an anti-slip coating on the top surface to prevent an item from slipping off the top surface when the sleeve is applied to a seat back tray table.

6. The protective sleeve as recited in claim 1, wherein the fastening device is provided on each of the pair of opposed side edges.

7. The protective sleeve as recited in claim 6, wherein the fastening device is selected from a group including clips, clasps, threads, hooks, loops, snaps, buttons, hook-and-loop fasteners and combinations thereof.

8. The protective sleeve as recited in claim 6, wherein the fastening device is a thread.

9. The protective sleeve as recited in claim 8, wherein the thread is elastic or has a rubberized coating.

10. A protective cover and tray table combination comprising;
a seat back travel tray secured to a seat by at least one support arm and movable from a closed position to an open position;
a protective cover sized and configured to substantially encompass the seat back travel tray, the protective cover having a front surface, a back surface, a pair of opposing sides, a front edge and a rear edge;
a plurality of securing threads attached to each of the pair of opposing sides of the protective cover; and
the protective cover formed from a flexible material having a thickness of at least 6 mils.

11. The protective cover and tray table combination as recited in claim 10, wherein the protective cover is provided with an anti-microbial component and an anti-bacterial.

12. The protective cover and tray table combination as recited in claim 11, wherein the anti-microbial and anti-bacterial components are applied to, or embedded, in the protective cover.

13. The protective cover and tray table combination as recited in claim 11, wherein the plurality of securing threads are secured to the at least one support arm.

14. The protective cover and tray table combination as recited in claim 13, wherein the plurality of securing threads are elastic and have a rubberized coating to grip the at least one support arm.

15. The protective cover and tray table combination as recited in claim 11, wherein the rear edge is open, the front edge is sealed, and the protective cover is placed over the seat back travel tray via the rear edge.

16. The protective cover and tray table combination as recited in claim 11, wherein the protective cover and seat back travel tray each have a deformation and the protective cover deformation is placed over the seat back travel tray deformation.

17. The protective cover and tray table combination as recited in claim 11, wherein the front surface of the protective cover is comprised of a high friction material or an anti-slip material.

18. A method of using a protective cover comprising the steps of:
providing a seat back tray table having a dimension of at least 16.5″ wide, 9.5″ deep and a thickness of 0.5″, the seat back tray table secured to a seat by at least one support arm and movable between a closed position to an open position;
manufacturing a protective cover which is sized and configured to substantially encompass the seat back tray table, the protective cover having a front surface, a back surface, a pair of opposing sides, an open front edge and a closed rear edge, wherein a plurality of securing elements is attached to each of the pair of opposing sides;
placing the protective cover over the seat back tray table via the open front edge; and
securing the protective cover to the seat back tray table with the plurality of securing elements.

19. The method of using a protective cover as recited in claim 18, wherein the step of manufacturing a protective cover includes embedding or coating an anti-microbial component and an anti-bacterial component in the protective cover.

20. The method of using a protective cover as recited in claim 18, wherein the plurality of securing elements is selected from a group including clips, clasps, threads, hooks, loops, snaps, buttons, elastic, hook-and-loop fasteners and combinations thereof.
